(19) United States
(12) Patent Application Publication
(10) Pub. No.: US 2003/0193960 A1
(43) Pub. Date: Oct. 16, 2003

(54) Method and system for processing business intelligence

(76) Inventor: Blane Stuart Land, Jacksonville, FL (US)

Correspondence Address: Kenneth A. Seaman, 219 Glen Oaks Road, Charlotte, NC, 28270, US

(21) Appl. No.: 10/335,480

(22) Filed: Dec. 31, 2002

Related U.S. Application Data
(60) Provisional application No. 60/372,448, filed on Apr. 16, 2002.
(60) Provisional application No. 60/400,134, filed on Aug. 2, 2002.
(60) Provisional application No. 60/404,751, filed on Aug. 21, 2002.

(51) Int. Cl. H04L 12/28

(52) U.S. Cl. 370/401

(57) ABSTRACT

A system and method of automatically processing event data representing business intelligence (content and context) wherein a business event is extracted from standard business software and transported by an electronic message such as a standard e-mail. The e-mail is then automatically sent to an e-mail server whose processor has knowledge of and access to a relational database. The gateway service determines that the event is associated with the database, captures the data for the event and intelligently determines a method of posting the event information into the database. In this way conventional database tools can be used to analyze the data regarding one or more events. Such an event processing system can be used to handle a variety of activities, such as time keeping and billing systems or compiling activity, performance and quality monitoring events using statistics from inspections and other processes in which data is captured and stored for later analysis

### CROSS REFERENCE TO RELATED PATENTS

The present invention claims the benefit under 35 USC 119 of the following provisional patent applications, the text of which are each specifically incorporated herein by reference:

U.S. provisional Patent Application Serial No. 60/372,448 Filed Apr. 16, 2002 and entitled “A Fully-automated, event-triggered, e-mail-based time billing system with e-mail-to-database gateway technology”. This patent is sometimes referred to herein as the “Billing System Patent”.

U.S. provisional Patent Application Serial No. 60/400,134 filed Aug. 2, 2002 and entitled “A fully automated, event triggered, email based quality tracking system”. This patent is sometimes referred to herein as the “Quality Tracking Patent”.

U.S. provisional Patent Application Serial No. 60/404,751 filed Aug. 21, 2002 and entitled “Method to integrate email, database and graphic planning tools into a unified solution for corporate planning, workflow tracking, real-time timekeeping, metrics collection and progress reporting”. This patent is sometimes referred to herein as the “Workflow Tracking Patent”.

### BACKGROUND OF THE INVENTION

1. Field of the Invention

The present invention is related to improvements in business methodology, electronic communication and data processing metric capture where one or more events are initiated using software on a computer work station or other data capture system and subsequently stored for record-keeping, project collaboration and subsequent data analysis purposes. More particularly, the present invention relates to methods and systems for monitoring and automatically recording historic data regarding significant events, automatically generating electronic messages (such as an e-mail) encapsulating details of the event (including relevant contextual information), transmitting the message (or e-mail) through a store-and-forward messaging system to a email gateway service where the event is recognized and intelligently transfers the information to a relational database for subsequent use and analysis, for example, by intelligently updating or inserting the details in a relational database. Information from the relational database can then be analyzed or otherwise processed using conventional business intelligence tools for analyzing the data, included but not limited to presenting summarized information to web portals or digital dashboards.

2. Background Art

Various systems are known or in common usage where as business event data becomes known an operator intervention is required to report the event. For example, manual entry timekeeping systems are in common use for billing and for project management. Various billing professionals, such as attorneys, accountants, architects and consultants, operating within complex corporate projects are interested in capturing project information with a minimum of effort and providing summary analysis without the delays of manual reporting. Such a professional may work on many different clients' work during a single day, and sometimes various matters for a single client. These professionals often base the charges on the amount of time spent and provide detailed records in support of that billing, such as the person doing the work, the date and time and the type of work; thus there is a need to have a simple, yet efficient, way to automatically capture the relevant event information in the process of normal workflow, where the operator is using familiar work tools such as email, project plans and word processing. Further more, it is desirable that this information be captured at the time the work is done and processed in an automated fashion, that is, without further manual handling of the data, which would consume additional time, effort and risk of error.

While different approaches have been proposed which address a data processing solution for time keeping and billing, these either have a conventional manual input system or a conventionally calculated output system and are therefore are inefficient and not adaptable to a wide spectrum of industries and companies. A customizable universal workflow model and solution is claimed that is adaptable across industries and business project practices independent of and including industries that use formal graphical planning tools.

Various other systems are known in the prior art for project management information collection and analysis, but these systems are either hard to use or have high resource costs to get the information into the system and then out in a useful format. For example, a project plan is usually created to manage a project and then activities are mapped against the project plan in order to determine whether the project is on track and within budget, but in many cases it requires the physical movement of data from one system to another for analysis. One way to manage such a project involves the printing of a PERT chart then mapping the activities on that PERT chart. Further, there is an increased emphasis on quality control in providing goods and services. However, there is no simple, inexpensive system for capturing the relevant information across multiple platforms and then transporting it and making it centrally available for business intelligence and analysis.

The prior art lacks a simple system for managing event data originating from common software tools, which in this invention is extracted, and transported asynchronously, then automatically transformed into a relational database transaction for subsequent use and analysis.

None of the known systems include a system in which an e-mail to database gateway is used to monitor and automatically convert the data from a discrete email record format into a relational database transaction from which reports can be quickly and easily generated using conventional tools.

It would desirable to provide a system, which bridges the information isolation between conventional platforms such as a store and forward messaging systems like e-mail and relational databases. The present IT solution environment does not have an encapsulating integrated business methodology that synthesizes the common IT platforms into a business event meta-solution, with an adaptable and customizable set of key bridging components that can bring business intelligence reporting into real-time.

Accordingly, the prior art systems have undesirable disadvantages and limitations and do not accomplish the stated objective of a desirable system for collecting, transporting, and consolidating business intelligence content.

### SUMMARY OF THE INVENTION

The present invention is an improved business methodology and data processing system for the capture and transport of business intelligence through the normal process of business workflow. The invention enforces “business process compliance”, eliminates inaccurate, redundant, manual time entry, and provides real-time process visibility for project costs and business milestones to management via a ‘knowledge management’ style digital dashboard imbedded in a common email client user interface.

The present invention overcomes the disadvantages and limitations of the prior art systems by providing a bi-directional information bridge or gateway between conventional data capture tools such as store-and-forward technology (sometimes referred to as e-mail) and conventional storage platforms such as relational databases.

The present invention has the advantage that it allows the conventional business software tools to be used and integrated into a system in which event information is automatically collected and transported in real-time. In this way business intelligence is accurate to the minute, instead of traditional analytics whose information may be days or weeks old. This represents a strategic advantage to large and complex projects involving dozens to thousands of time billing professionals.

The present invention has the advantage that it allows event data to be easily and quickly collected with a minimum of overhead (time spent in creating and handling the information).

The present invention also has the benefit that it employs conventional tools for data analysis (such as a relational database, database query tools, and web based portal/digital dashboard outputs) for obtaining and analyzing the event data stored in a relational database.

An additional advantage of the present invention is that the business event monitoring can be done on any platform and integrated into a real time scorecard of critical success factors with a minimum of cost and overhead.

A third advantage of the present system is that the gateway technology of the present invention is suitable for use in a variety of applications where event data is collected for storage and later analysis.

While the present invention is described somewhat specifically in the context of the preferred embodiments of an email to database gateway which may be used to advantage in a time billing system and/or a quality monitoring system and/or a workflow monitoring application, the present invention is not so limited, either in construct or in application.

Other objects and advantages of the present invention will be apparent to those skilled in the relevant art in view of the following description of the preferred embodiments, taken together with the accompanying drawings and the appended claims.

### BRIEF DESCRIPTION OF THE DRAWINGS

Having thus described some objects and advantages of the present invention, the present invention of an improved event information capture and analysis system and method is described in connection with the accompanying drawings in which:

FIG. 1 is a pictorial overview of a data processing system, which uses the present invention;

FIG. 2 is a flow chart illustrating in general the logic of the present invention;

FIG. 3 is a sample of a data entry screen for a time-billing system using the present invention;

FIG. 4 is a sample of a portion of a database created using the time-billing information generated from FIG. 3

FIG. 5 is a sample data entry screen for a quality monitoring application of the present invention;

FIG. 6 is a portion of a database, shown updated to reflect the data from FIG. 5;

FIG. 7 is a sample data entry for a workflow management embodiment of the present invention; and

FIG. 8 is a flow chart illustrating the logic of the gateway of the present invention.

### DETAILED DESCRIPTION OF THE PREFERRED EMBODIMENT

In the following description of the preferred embodiments, the best implementations of practicing the invention presently known to the inventor will be described with some particularity. However, while this description is intended as a broad, general teaching of the concepts of the present invention using several specific embodiments, it is not intended to be limiting the present invention to the implementation as shown in any of these embodiments, especially since those skilled in the relevant art will recognize many variations and changes to the specific techniques and methods of operation shown and described with respect to these figures. Also, the present invention will be discussed in terms of a remote data storage system using electronic communication (such as, but not limited to email) over a data transmission network. The gateway described herein will be discussed in terms of two illustrative applications, although other applications are certainly feasible using the system and methods of the present invention and intended to be covered by this patent.

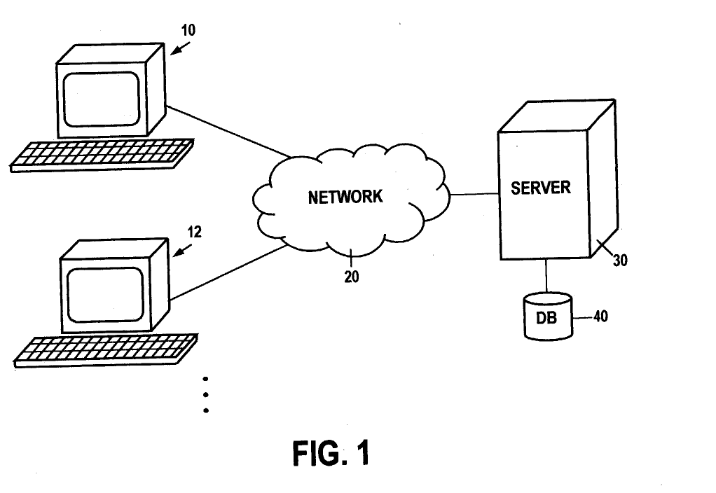

FIG. 1 illustrates generally a data generation and collection system of the present invention. As shown in this FIG. 1, a first workstation 10 and a second workstation 12 are each connected to a data transmission network 20 for communicating e-mail to the data transmission network 20. Also connected to the data transmission network 20 is a server 30 for receiving and processing e-mail and database inquiries. Associated with the server 30 is a data storage device 40, which includes a relational database for storage of event data in the relational database. A gateway service as described in connection with FIG. 9 is associated with the server 30 for extracting event data from the e-mail and for transacting the inclusion of such data appropriately in the relational database.

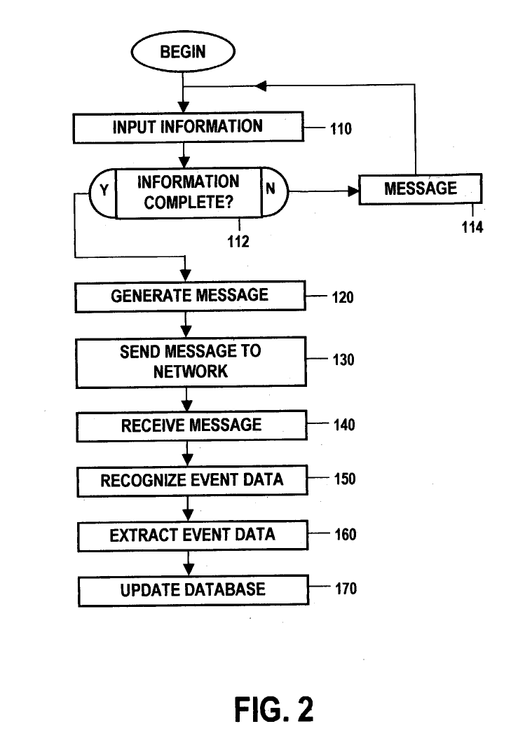

FIG. 2 shows a block diagram of a process for processing event data using the present invention. The process starts at block 110 with the input of information from a process that generates the information, be it a time-keeping application where a time record is generated or an inspection report for a quality monitoring application or a report for workflow monitoring application.

The first step is to determine at block 112 whether the information is complete. This is a test, based on stored rules for the content of each message, whether it contains the information necessary to be included in the database. This test implements a fundamental rule for a database system of the present invention, that is, never send a message without sending all the relevant details such as the contextual information. Ideally, the message is generated with key pieces of the information already filled in, such as the date, project, sender, etc., to make it easy to comply with this. In one application of the present invention, the initial project assignment provides a message in the form of an e-mail to the assigned resource and as the recipient resource opens his assignment, the opening triggers an automated timekeeping component on his desktop which automatically logs time to the associated project and task.

If the information is determined at block 112 to be complete, then control passes to the next functional block 120, but if the information is incomplete (a piece of necessary contextual information is missing), then a message is generated advising the user of the error and control returns to the input information block 110.

Next, at block 120, the data from the input of information is extracted and included in an electronic message, such as an email, that is, an e-mail is generated from the input information. The message (e-mail) is then send to the network at block 130 for forwarding to the appropriate destination. At block 140 the destination receives the message (e-mail) and at block 150 recognizes it as a data about an event for a database. At block 160, the event information is extracted from the e-mail and at block 170 the event information is used to update the database.

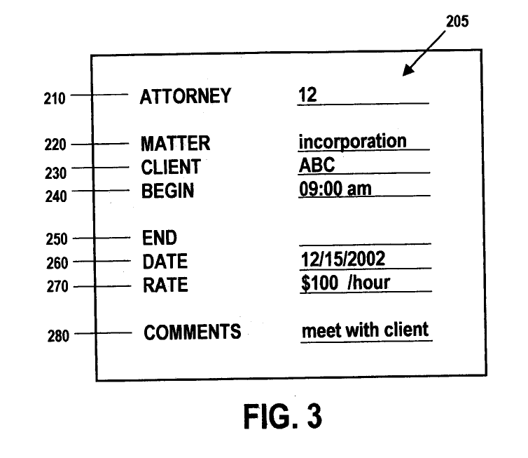

FIG. 3 illustrates a representative set of event information used in the time-keeping and billing application, for example, as is described in the Billing System Patent described above. As shown in this illustration, when a user desires to input information, he calls up a template 205 on his workstation 205 which has various categories and blanks where inputs can be made. For example, in this time billing system for attorneys, there is a blank 210 for identification of the attorney which has a number 12 included to identify the attorney (of course, any other form of identification of the attorney could also be used to advantage, for example, last name or initials, provided that they are unique; in a small organization, last names or initials may be unique, but in larger groups of approximately 100, some duplication is possible in names—two Smiths or two Jones are likely—or initials—where R A J could be Robert A. Jackson or Richard A. Johnson or Roberta Ann James). A blank 220 for the matter is completed with the type of work performed, usually from a menu of types of service, in this case, incorporation. A bank 230 is provided to identify the client and blanks 240 and 250 are provided for beginning and ending times (of course, an attorney might only enter the beginning time, which might default to the current time unless changed, when a matter is commenced, then a second entry is made when the attorney ends the work on one matter, as by starting another or by ending his work, either for the day or for a non-billed activity like lunch or administrative duties. Blank 260 is for the date, again with the current information being a default which can be changed if desired. By a default entry for a blank, it is understood that the date appears to be accepted or changed (or even deleted, in the case of beginning or ending times). A blank 270 for the charge rate is provided and, again, a default rate can be associated with an attorney, subject to be varied if the service is worth less or more than the default rate (as might occur with a fixed fee service). A blank 280 for comments allows for additional detail to be provided (and possibly included later in the database and the bill) for the service to record details of the activity, perhaps a meeting with others and perhaps for detailing the scope of research, the particulars of litigation or other information which is of value to the attorney or the client.

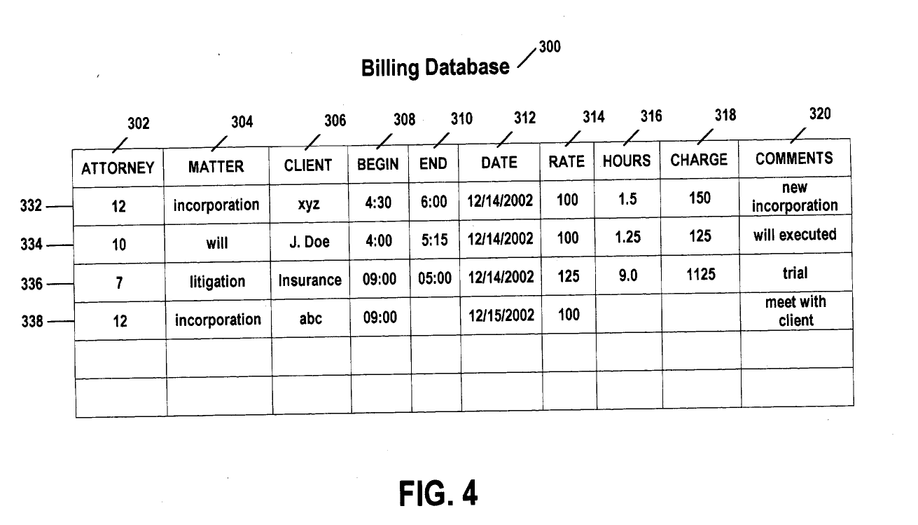

FIG. 4 illustrates a portion of a billing database, which has been updated using the data of FIG. 3 at line 338. Previous entries for events (time entries) are shown on lines 332, 334, 336. Each line includes entries in some (but not necessarily all) of the columns of the database, where the columns are for attorney (302), matter (304), client (306), begin time (308), end time (310), date (312), rate (314), hours (316), charge (318) and comments (320).

In the case of the time record shown in FIG. 3, only a begin time is shown (9:00 am) indicating that the work began at 9:00 but had not yet been completed. This entry is then completed when the attorney starts work on a different matter (logging out of one activity to start work on another, perhaps as a result of receiving a telephone call or beginning a meeting) or when the attorney ends work (by lunch or the end of the day or to attend to non-billing work such as a staff meeting).

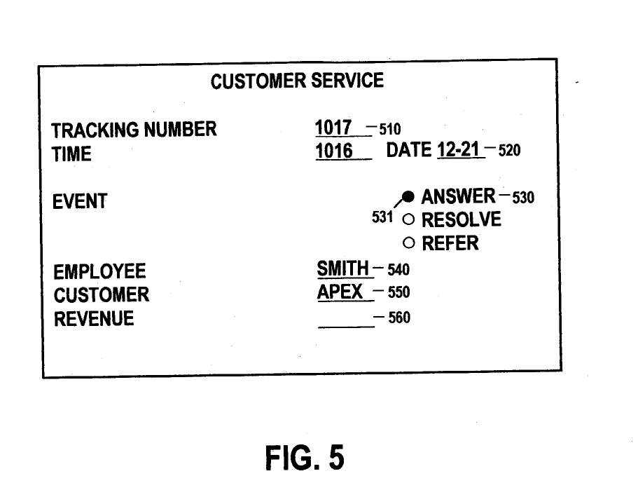

FIG. 5 is a picture of a sample screen for entering data for quality monitoring, shown in the context of a customer service situation (although the quality monitoring of the present invention could be used for monitoring quality of a manufacturing process or other similar situation where data is generated about a series of activities and later analyzed for trends and performance indicators). In this screen, a customer service representative at a call center is receiving inquiries from customers (for example, how to use a computer product such as software and/or providing warranty support or technical service to customers and service representatives). When a call comes in, it is assigned a tracking number which is entered on line 510. At the time an action is reported, then the present time and date are filled in on lines 520. The service representative then has a choice of marking the call as an answer, resolve or refer at location 530, and in this case the representative marks the type as “answer” indicating that he has answered the phone but not yet determined what the customer needs. Line 540 is for the employee's name (in this case, the terminal is for “Smith” and his name is pre-filled out on the screen. There is a line 550 for the name of the customer (Apex) representing any appropriate identification data such as billing name and address, and a line 560 for the revenue associated with the transaction (which is left blank since it has not been determined whether there will be a charge and if so, how much.

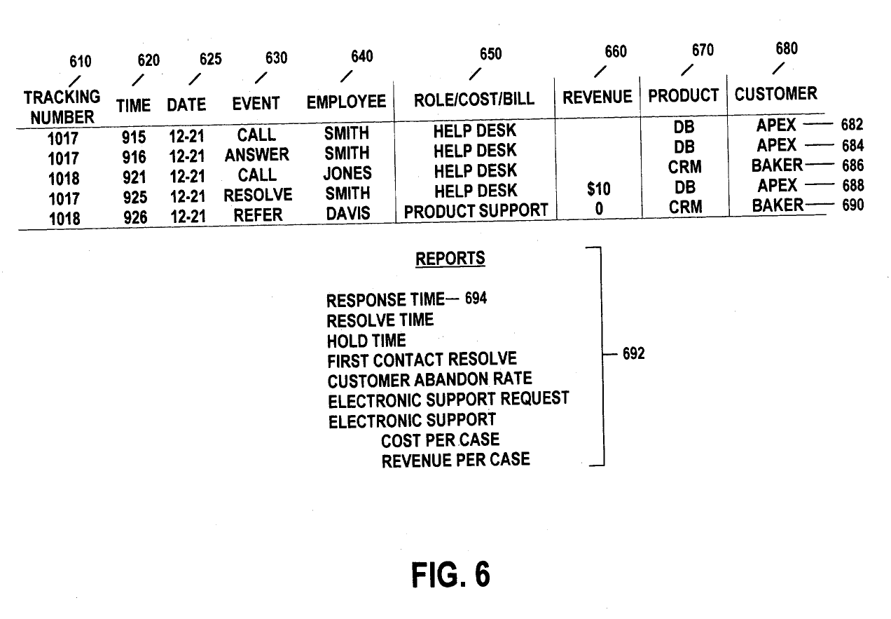

FIG. 6 illustrates a portion of a quality monitoring database or repository of event information. As shown in this view, a column 610 is for the tracking number, column 620 is for the time, with columns 625 for the date, 630 for the event, 640 for the employee, 650 for the role/cost/bill (related to the employee handling the matter). Columns 660 receive the revenue information (the charge for the service), 670 for the product (or technology involved) and column 680 for the customer. Of course, additional information of different kinds can be collected in the data entry process of FIG. 5 and accumulated for analysis in the database or repository of FIG. 6 as desired by the customer and the needs of his business.

Shown below the database is a list 692 of several types of reports which can be generated for the database of FIG. 6, such as the response time 694, which can be analyzed as average time, best/worst case, standard deviation, etc. Cost, revenue, times for response or resolution can be monitored as desired by using an appropriate tool for structured queries to the database and can be generated using the data which is available.

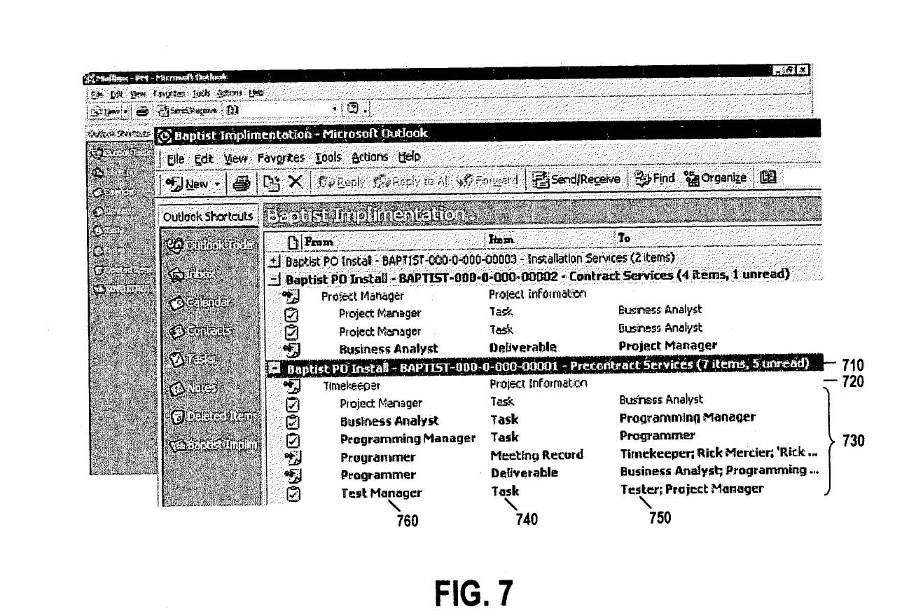

FIG. 7 shows a portion of a repository for event monitoring in a project management situation where the entries for one of the tasks are shown (in this case, for Precontract services, indicated by line 710). For this task, there is a timekeeper line 720 and several activities are shown by the lines marked by 730. For each of the entries for each activity, there is a message about a subject in column 740, which has been send to a recipient named in column 750 by an author listed in 760. Ideally, the author pointed to the project and the type of response (task assignment, deliverables, status report, meeting record or project report) and obtained a message with the key information pre-filled out so that it became impossible for him to get the wrong project or the wrong activity. Also, as the message is pre-addressed to the appropriate recipient it is also copied to the repository so that all those associated with the project can see the materials which have been generated for the project, all aligned with the appropriate task and showing the author, recipient and type of material. This makes it easy for review of the documents of interest regarding the tasks of interest and results from having ach task provided with identification and each report matched to the project and the task with a copy in the repository. At the same time, the use of the project documents can allow for the automatic keeping of time and the accumulation of time and costs to the project in real time without additional time records or the manual recording of time.

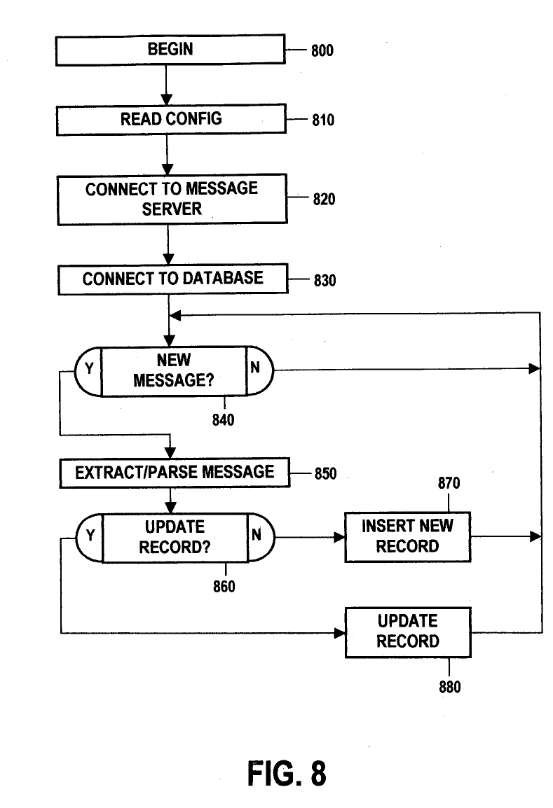

FIG. 8 shows the detail of the gateway, which is useful in the present invention. As shown in this FIG. 8, the process begins when the machine is initialized or turned on at block 800, then the configuration information is read at block 810, including the name of the database server and mail server and the location of the mailbox to monitor. At block 820 a connection to the message server is made and at block 830 a connection is made to the database. At block 840 the monitoring of the mailbox for new messages is shown, with the presence of a new message being the test. When a new (unprocessed) message is identified in the mailbox, the at block 850 the message is extracted and the content is parsed, that is, if any part of the message is in XML format, then content is removed from extraneous information. Next at block 860 it is determined using stored rules whether the message is an update message or record (an update of a previous message or record) or a new message or record. If the message is not n update to an existing message, then it must be a new record and a new entry is made to the database at block 870. If a message is identified as an update message, then the message for which it is an update is identified and updated at block 880. Of course, many modifications of the present invention will be apparent to those skilled in the relevant art in view of the foregoing description of the preferred embodiment, taken together with the accompanying drawings and the appended claims. For example, the use of e-mail as a store and forward utility for data capture is advantageous but not required, as other forms of data input could be used to advantage in connection with the present invention. Accordingly, the use of an e-mail application is disclosed in connection with the preferred embodiment, but the present invention is not limited to the particular applications that are depicted and discussed in the foregoing description of the preferred embodiments. Additionally, those skilled in the art will realize that the present invention is not limited to data transmission using e-mail over a data transmission network such as the Internet, as the data storage device could be local or connected over a dedicated network such as a virtual private network. Also, it will be appreciated that the transmission and reception of such information could be accomplished in a different format or using different protocols. Also, another type of storage and retrieval system could be used to advantage, if desired, in place of a relational database. Further, some elements of the present invention can be used to advantage without the corresponding use of other elements. Further, the use of conventional data processing tools such as database search and reporting tools, while desirable, is not required for the successful use of the present invention. Also, while the present system has been described in connection with real-time messages, the system could operate in a “mixed mode” where some off line users create “event” information is stored locally and processed by periodically connecting to the network for electronic communication. This would allow the system to support operators in a disconnected mode, either when the network is down or to allow for use in a remote (no network) environment or to allow for intermittent connection to the network. Further, the present invention may be modified to be useful in other applications where data is generated and stored for later analysis such as Business Activity monitoring (BAM) where data is extracted and transported from existing operational systems (whether military, custom business systems or commercial ERP systems. While the description contained in this document is necessary somewhat specific to provide an enabling teaching of the preferred embodiment(s), those skilled in the art would be aware of many modifications and adaptations to the present invention to achieve a similar result. Accordingly, the foregoing description of the preferred embodiment(s) should be considered as merely illustrative of the principles of the present invention and not in limitation thereof.

Having thus described the invention, what is claimed is:

1. A system for receiving event information and storing it for further processing, the system comprising:
a data capture device which receives data about an event and creates an electronic message including the data and relevant contextual information;
a communications system coupled to the data capture device for electronically transmitting the message including the data to a data storage device;
a data storage device coupled to the communications system for receiving a storing the data about the message, said data storage device including database software for storing data about the event in the database; and
a gateway coupled to the data storage device for recognizing a message which has been created by the data capture device and for extracting the data from the message and storing the data to the database.

2. A system of the type described in claim 1 wherein the database is a relational database and the system further includes conventional tools for retrieving and analyzing data from the relational database.

3. A system of the type described in claim 1 wherein the data capture device is a personal computer that is used to capture event information entered into the personal computer.

5. A system of the type described in claim 1 where the data is quality information and the data capture device is a system for providing quality information from a business process.

6. A system of the type described in claim 5 wherein the system for providing quality information from a customer service facility.

7. A system of the type described in claim 1 wherein the system includes a test to determine that the data is adequate for the database before it is forwarded.

8. A system of the type described in claim 1 wherein the system for providing event information is a system for workflow tracking.

9. A system of the type described in claim 8 wherein the system for workflow tracking provides a repository of all project related documents, which are displayed by task.

10. A method of creating and storing data from an event for future use and analysis, the steps of the method comprising:
generating an electronic message including context and data representing the event;
forwarding the electronic message to a device for processing the electronic message, said device having associated therewith a database for storing information from said electronic messages;
determining at the processing device that the message represents an event;
if the message represents an event, determining the data from the message which is to be stored in the database and storing it in the database as representing the event; and
allowing for the subsequent analysis of the data in the database using suitable database tools to retrieve and analyze such messages.

11. A method of processing messages including the steps of claim 10 wherein the messages are records of time events and the database includes billing information.

12 A method of processing messages including the steps of claim 10 and further including the step of testing each message for completeness before transmitting it.

13. A method of processing messages including the steps of claim 10 wherein the method further includes the step of providing an input document, which is partially completed with relevant data based on the project and task, whereby the project and task need not be entered and whereby the project and task can not be incorrectly entered.

14. A method of processing messages including the steps of claim 13 wherein the system includes a method of assigning tasks to a resource by pointing at the task, which causes a boc to pop up and allow for the indication of the resource assigned to the task.

15. A method of processing messages including the steps of claim 10 wherein the messages indicate the results of inspections and the database includes information for quality analysis.

16. A method of processing messages includes the steps described in claim 10 wherein the system includes a repository and the method includes the step of automatically copying each message about the project to the repository.

17. A method of processing messages of the type described in claim 10 where the system includes a database and each resource includes a timer for recording time spent on a task, wherein the method includes the step of periodically forwarding a report of the time spent on a task to the repository.

18. A method of processing messages including the steps of claim 10 wherein the system includes some messages which are updating to previous messages and other messages which are not updating of previous messages and the method includes the step of testing each message to determine whether it is an updating message, whereby an updating message may be used to update the previous message.

19. A method of processing messages including the steps of claim 18 wherein the step of determining whether a message is an updating message including a testing of the message according to some rules and some past message.

20. A method of processing messages including the steps of claim 10 wherein the messages provide workflow tracking and the steps of the method include providing a message which is chosen from the types of making a task assignment, providing deliverables, making a status report, recording meeting information and providing project reports and each document is identified by the type of document, with the type entered into the repository.
